(19) United States
(12) Patent Application Publication
(10) Pub. No.: US 2007/0077383 A1
(43) Pub. Date: Apr. 5, 2007

(54) Heat insulating material

(75) Inventor: Kiyonari Hatanaka, Ogaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: IBIDEN CO., LTD., Ogaki-shi (JP)

(21) Appl. No.: 11/522,941

(22) Filed: Sep. 19, 2006

(30) Foreign Application Priority Data
Sep. 30, 2005 (JP) 2005-288665

(51) Int. Cl. B32B 1/08

(52) U.S. Cl. 428/36.91

(57) ABSTRACT

A heat insulating material of the present invention comprises: a hollow molded body made of at least an inorganic fiber; and a filler which is filled in a hollow part of the hollow molded body and made of at least an inorganic powder.

### CROSS-REFERENCE TO RELATED APPLICATIONS

This application claims priority of Japanese Patent Application No. 2005-288665 filed on Sep. 30, 2005. The contents of this application are incorporated herein by reference in their entirety.

### BACKGROUND OF THE INVENTION

1. Field of the Invention

The present invention relates to a heat insulating material.

2. Discussion of the Backgruond

As the heat insulating material conventionally used in a fuel cell and the like, products prepared by mixing an inorganic powder such as silicone oxide and titanium oxide in a dry system and then molding the mixed powder by a press are known. These heat insulating materials have high heat insulation properties because they respectively have a porous structure wherein voids existing in the structure are divided by fine particles.

However, conventional heat insulating materials are plate shaped heat insulating materials which are made from brittle materials containing 90% or more of a fine powder and also molded through dry pressing. Therefor, these heat insulating materials have significantly inferior moldability and flexibility. These heat insulating materials have the problem that when subject bodies to be insulated having curved surfaces or complex shapes are coated with such a heat insulating material, it is necessary, for example, to make them into an appropriate shape by mechanical processing or to coat these heat insulating materials with materials such as glass-fiber cloth and the like so as to reinforce the heat insulating material. There is also the problem that when plural plate shaped heat insulating materials are used to coat subject bodies to be insulated having curved surfaces or complex shapes therewith, voids are easily generated among heat insulating materials and between the heat insulating material and the subject body to be insulated, leading to a decrease in heat insulation properties thereof.

In order to solve such a problem, in JP-A 11-280989, for example, a method is proposed in which a slit is formed on a molded body for a heat insulating material to coat a subject body to be insulated under vacuum when the subject body to be insulated, such as a tube and cylinder, having a curved surface is coated with the heat insulating material. According to the above-mentioned document, it is described that the generation of voids when a heat insulating material is set to a curved surface can be suppressed.

In the meantime, a heat insulating material with ceramic fibers knitted cloth-wise (or fabric-wise) is known as a heat insulating material having processability and moldability (see, for example, JP-A 9-249445).

The contents of JP-A 11-280989 and JP-A 9-249445 are incorporated herein by reference in their entirety.

### SUMMARY OF THE INVENTION

A heat insulating material according to the embodiments of the present invention comprises:

a hollow molded body made of at least an inorganic fiber; and

a filler which is filled in the hollow part of the hollow molded body and is made of at least an inorganic powder.

The inorganic fiber contained in the hollow molded body desirably has an average fiber length of at least about 0.1 mm and at most about 50 mm, more desirably an average fiber length in the range of about 0.5 mm to about 10 mm.

The inorganic fiber contained in the hollow molded body desirably has an average fiber diameter of at least about 1 μm and at most about 10 μm, more desirably an average fiber diameter in the range of about 2 μm to about 5 μm.

The compounding amount of the inorganic fiber in the hollow molded body is desirably at least about 5% by weight and at most about 50% by weight, more desirably in the range of about 10% by weight to about 40% by weight.

The hollow molded body preferably further contains an inorganic powder, and the compounding amount of the inorganic powder in the hollow molded body is desirably at least about 50% by weight and at most about 95% by weight, more desirably in the range of about 60% by weight to about 90% by weight.

The average particle diameter of the inorganic powder contained in the hollow molded body is desirably at least about 0.5 μm and at most about 20 μm, more desirably in the range of about 1 μm to about 10 μm.

The inorganic powder contained in the hollow molded body desirably has a ratio of refractive index of about 1.25 or more for light having a wavelength of 1 μm or more.

The inorganic powder contained in the hollow molded body desirably has a reflectance of about 70% or more for light having a wavelength of 10 μm or more.

The solid heat conductivity of the inorganic powder contained in the hollow molded body is desirably about 20.9 W/mK or less at room temperature.

The hollow molded body desirably further contains an inorganic binder.

The hollow molded body desirably further contains an organic elastic material.

The wall thickness of the hollow molded body is desirably at least about 3 μm and at most about 20 μm.

A part or all of the hollow molded body is desirably made to have a densified structure.

The bulk density of the hollow molded body is desirably at least about 0.35 g/cm³ and at most about 0.45 g/cm³.

The inorganic powder contained in the filler desirably has an average particle diameter of at least about 0.5 μm and at most about 20 μm, more desirably an average particle diameter in the range of about 1 μm to about 10 μm.

The inorganic powder contained in the filler desirably has a ratio of refractive index of about 1.25 or more for light having a wavelength of 1 μm or more.

The inorganic powder contained in the filler desirably has a reflectance of about 70% or more for light having a wavelength of 10 μm or more.

The solid heat conductivity of the inorganic powder contained in the filler is desirably about 20.9 W/mK or less at room temperature.

Moreover, the filler preferably further contains an inorganic fiber.

The average fiber length of the inorganic fiber contained in the filler is desirably at least about 0.1 μm and-at most about 50 μm, more desirably in the range of about 0.5 μm to about 10 μm.

The average fiber diameter of the inorganic fiber contained in the filler is desirably at least about 1 μm and at most about 10 μm, more desirably in the range of about 2 μm to about 5 μm.

The filler preferably has a bulk density of at least about 0.15 g/cm³ and at most about 0.4 g/cm³.

The hollow molded body is preferably a molded body obtained by wet molding.

### BRIEF DESCRIPTION OF THE DRAWINGS

FIG. 1A is a perspective view schematically showing an example of a heat insulating material according to one embodiment of the present invention which is set to a fuel cell reformer; FIG. 1B is a perspective view schematically showing one example of a hollow molded body constituting a heat insulating material according to another embodiment of the present invention; and FIG. 1C is a perspective view schematically showing another example of a hollow molded body constituting a heat insulating material according to yet another embodiment of the present invention.

FIG. 2 is a graph obtained by plotting the difference between a change in the bulk density (g/cm³) of the filler and a change in the thermal conductivity (W/mK) of the integrated molded type heat insulating material according to the embodiments of the present invention when the heat insulating material is heated to 600° C., shown in Table 1.

### DESCRIPTION OF THE EMBODIMENTS

A heat insulating material according to the embodiments of the present invention comprises:

a hollow molded body made of at least an inorganic fiber; and

a filler which is filled in a hollow part of the hollow molded body and is made of at least an inorganic powder.

(Hollow Molded Body)

The hollow molded body is made of at least an inorganic fiber.

Examples of the inorganic fiber include silica-alumina fiber, alumina fiber, silica fiber, zirconia fiber, glass fiber and potassiumtitanate whisker fiber. The use of these inorganic fibers is desirable in view of heat resistance, strength and availability. The above-mentioned inorganic fibers may be used independently or two or more kinds thereof may be used in combination.

Among the above-mentioned inorganic fibers, particularly silica-alumina fiber is preferably used from the viewpoint of heat resistance and handling characteristics.

The cross-sectional shape of the inorganic fiber is not particularly limited and examples thereof include a circular cross-section, flat cross-section, hollow cross-section, polygonal cross-section and sheath-core cross-section. Because modified cross-section fiber having a hollow cross-section, flat cross-section or polygonal cross-section among these sections tends to increase in opportunities to reflect radiation heat transfer in heat transfer and also tends to slightly improve in heat insulation property, it can be preferably used.

The lower limit value of the average fiber length of the inorganic fiber is preferably about 0.1 mm and more preferably about 0.5 mm. On the other hand, the upper limit value of the average fiber length of the inorganic fiber is preferably about 50 mm and more preferably about 10 mm.

When the average fiber length of the inorganic fiber is about 0.1 mm or more, entanglements among inorganic fibers are easily caused and thus it becomes easier to achieve a sufficient mechanical strength of the obtained hollow molded body. On the other hand, when the average fiber length is about 50 mm or less, inorganic fibers are likely to be tightly entangled with each other, so that the case only the single inorganic fibers are intertwined into a ball can be prevented, and thus continuous voids are less likely to be generated, thereby it is likely that a sufficient heat insulation property is obtained.

The lower limit value of the average fiber diameter of the inorganic fiber is preferably about 1 μm and more preferably about 2 μm. On the other hand, the upper limit value of the average fiber diameter of the inorganic fiber is preferably about 10 μm and more preferably about 5 μm.

This is because when the average fiber diameter of the inorganic fiber is about 1 μm or more, the mechanical strength of the inorganic fiber itself tends to become high, whereas when the average fiber diameter is about 10 μm or less, solid heat conduction through the inorganic fiber as a medium may be prevented from increasing, and thus a sufficient heat insulation property of the heat insulating material is likely to be obtained.

The hollow molded body preferably further contains an inorganic powder.

The hollow molded body constituting the heat insulating material according to the embodiments of the present invention should contain at least an inorganic fiber. The use of such a hollow molded body allows the heat insulating material according to the embodiments of the present invention to produce its effect as a heat insulating material; however, it is desirable that the hollow molded body further contains an inorganic powder.

If the hollow molded body further contains the inorganic powder, radiation heat transfer tends to be suppressed efficiently. Also, the continuous voids in the structure, which voids are caused by entanglement of the inorganic fibers, tends to be easily divided and therefore it may be possible to also easily reduce convection heat transfer in the hollow molded body in an efficient manner.

Examples of the inorganic powder include a TiO₂ powder, BaTi₃ powder, PbS powder, Sio₂ powder, ZrO₂ powder, SiC powder, NaF powder and LiF powder. These inorganic powders may be used independently or two or more kinds thereof may be used in combination.

When the inorganic powders are used in combination, preferable examples of the combinations include a combination of a TiO₂ powder and SiO₂ powder, a combination of a TiO₂ powder and BaTi₃ powder, a combination of a SiO2 powder and BaTi₃ powder, and a combination of a TiO₂ powder, SiO₂ powder and BaTi₃ powder.

As to the amount of the compounding amount of the inorganic fiber, the upper limit value thereof is preferably about 50% by weight and more preferably about 40% by weight based on the total weight of the materials constituting the hollow molded body. On the other hand, the lower limit value of the compounding amount of the inorganic fiber is about 5% by weight and more preferably about 10% by weight.

When the compounding amount of the inorganic fiber is about 5% by weight or more, the reinforcing effect produced by the inorganic fiber may be sufficiently obtained and therefore, it is likely that sufficient handling characteristics and mechanical strength of the hollow molded body or heat insulating material are obtained. When the compounding amount of the inorganic fiber to be compounded is about 50% by weight or less on the other hand, many continuous voids may be prevented from being generated in the structure in which the inorganic fibers constituting the hollow molded body are entangled, there by easily suppressing an increase in convection heat transfer, molecular heat transfer and radiation heat transfer to readily obtain a sufficient heat insulation property.

As to the compounding amount of the inorganic powder, the upper limit thereof is preferably about 95% by weight and more preferably about 90% by weight based on the total weight of the materials constituting the hollow molded body. On the other hand, the lower limit of the compounding amount is preferably about 50% by weight and more preferably about 60% by weight.

When the compounding amount of the inorganic powder is at least about 50% by weight and at most about 95 % by weight, it becomes easier to reduce the radiation heat transfer while retaining the reinforcing effect of the inorganic fiber. Also, the effect of decreasing convection heat transfer which is obtained by dividing continuous voids in a confounded structure of the inorganic fiber can be more easily obtained.

The lower limit value of the average particle diameter of the inorganic powder is preferably about 0.5 μm and more preferably about 1 μm. On the other hand, the upper limit value of the average particle diameter of the inorganic powder is preferably about 20 μm and more preferably about 10 μm.

When the average particle diameter of the inorganic powder is about 0.5 μm or more, not only does it become easier to manufacture a heat insulating material but also the thermal conductivity of a heat insulating material tends to be prevented from increasing because radiation heat tends to be distributed sufficiently. When an inorganic powder having an average particle diameter of about 20 μm or less is used on the other hand, voids produced in the heat insulating material tends to be prevented from becoming large, thereby readily suppressing an increase in convection heat transfer and molecular heat transfer to obtain an extremely sufficient heat insulation property with more ease.

The shape of the inorganic powder is not particularly limited as long as the average particle diameter is within the above-mentioned range. Examples of the shape include desired shapes such as a spherical shape, elliptical shape, polygonal shape, shapes having irregularities or projections formed on the surface thereof and deformed shapes.

Also, the inorganic powder preferably has a ratio of refractive index (specific refractive index) of about 1.25 or more for light having a wavelength of 1 μm or more.

The inorganic powder plays a very important role as a radiation heat diffusing material. As the refractive index increases, radiation heat is likely to be diffused more efficiently. As to the specific refractive index, it is very important to limit the conduction of phonons. The larger this value is, it is likely that a superior effect of limiting phonon conduction is obtained. Therefore, the value of the specific refractive index of the inorganic powder is about 1.25 or more in the embodiments of the present invention.

Here, to add a little more explanation concerning the limitation to phonon conduction, materials having lattice defects in a crystal or materials having a complicated structure are generally known as the material that can limit phonon conduction. The aforementioned TiO₂, SiO₂ and BaTiO₃ tend to have lattice defects and have a complicated structure and it is therefore considered that they are effective to diffuse not only radiation heat but also phonons.

Moreover, an inorganic powder having a reflectance of about 70% or more for light having a wavelength of 10 μm or more may be preferably used as the inorganic powder. The light having a wavelength of 10 μm or more is light in the so-called infrared to far-infrared wavelength range. Radiation heat transfer tends to be reduced more efficiently if the reflectance for light in the above wavelength range is about 70% or more.

The solid heat conductivity of the inorganic powder is preferably about 20.9 W/mK or less at room temperature.

If an inorganic powder has a solid heat conductivity at ambient temperature in such a range, solid heat conduction is less likely to affect the heat insulating material and therefore the thermal conductivity tends to be prevented from increasing, thereby obtaining a sufficient heat insulation property more easily.

Here, the inorganic fiber refers to an inorganic fiber having an aspect ratio of about 3 or more. On the other hand, the inorganic powder refers to an inorganic powder having an aspect ratio of less than about 3. In this case, the aspect ratio is the ratio (b/a) of the major diameter (b) to minor diameter (a) of a material.

Also, the hollow molded body may contain an inorganic binder with the intention of maintaining strength at high temperatures. Examples of the inorganic binder include colloidal silica, synthetic mica and montmorillonite. The above-mentioned inorganic binders may be used independently or two or more kinds thereof may be used in combination.

This inorganic binder may be desirably used, according to the need, in an amount of at least about 1% by weight and at most about 10% by weight based on the total weight of the constituent materials of the hollow molded body. As a mode of use of the above-mentioned inorganic binder, the binder may be used by blending it in raw materials or by impregnating the obtained heat insulating material therewith.

In the embodiments of the present invention, an organic elastic material may be used according to the need as the constituent materials of the hollow molded body. This organic elastic material is useful to manufacture a heat insulating material which is to be used in the parts requiring flexibility. As the elastic material, an emulsion of natural rubber, acrylonitrile butadiene rubber (NBR) or synthetic rubber latex binder such as styrene butadiene rubber (SBR) may be preferably used. Particularly, in the case of manufacturing the heat insulating material according to the embodiments of the present invention in a wet method, the flexibility tends to easily be improved by using the organic elastic materials.

The compounding amount of the organic elastic material is preferably at least about 0% by weight and at most about 5% by weight based on the total weight of the constituent materials of the hollow molded body.

The organic elastic material may be contained or not contained as the constituent materials. However, if the compounding amount of the organic elastic material is in the above-mentioned range, the organic elastic material is less likely to be burned down even when it is used at a high temperature range of about700° C. or more, and thereby voids tend to be preventedfrom increasing to obtain a sufficient heat insulation property more easily.

The hollow molded body constituting the heat insulating material according to the embodiments of the present invention is a molded body obtained by molding inorganic fiber and the like into a desired shape by a dry molding method or a wet molding method and has a hollow part that can be filled with a filler. A method for manufacturing the hollow molded body will be described later.

The hollow molded body may have any shape without any particular limitation as long as it has a hollow part. Examples of the shape of the hollow molded body include a cube shape, a rectangular parallelepiped shape, a plate shape, disk, a cylindrical shape, a double-tube type shape, a triple-tube type shape, a doughnut type shape or a spherical shape. The heat insulating material which is constituted of a hollow molded body like this is free from the necessity for dividing it when it is assembled and therefore, it is likely to more easily be assembled integrally and entirely in a subject material to be insulated which has a curved surface.

The wall thickness of the hollow molded body is preferably at least about 3 mm and at most about 20 mm though no particular limitation is imposed thereon. The wall thickness of the hollow molded body refers to a maximum thickness among the wall thicknesses of parts extended from the outside surface to the hollow part of the hollow molded body in the case of a double-tube type hollow molded body.

When the wall thickness of the hollow molded body is about 3 mm or more, it becomes easier to impart sufficient mechanical strength to the heat insulating material, whereas when the wall thickness is about 20 mm or less, not only does the molding of the hollow molded body itself tends to become easier but also an appropriate amount of the filler may be filled in the hollow part, so that the filler is likely to exert a sufficient insulating action.

When the inorganic powder is contained in addition to the inorganic fiber as the constituent material of the hollow molded body, the inorganic powder and the filler (described later) filled in the hollow part do not easily escape out of the hollow molded body. According to the need, a part or all of the hollow molded body may be made to have a more densified structure for the purpose of preventing the escape of the inorganic powder and the filler.

Particularly, even in the case where the inorganic powder is contained as the constituent material of the hollow molded body, since the inorganic powder constituting the hollow molded body is included in a structure in which the inorganic fibers are entangled the inorganic powder is not escaped externally from between the inorganic fibers with ease in the heat insulating material according to the embodiments of the present invention. However, because it is considered to be possible that a load of very strong impact is applied to the heat insulating material depending on the working environment, and the inorganic powder is escaped in the air, the inorganic fiber structure of the part including the inorganic powder is densified to prevent the inorganic powder from escaping.

As a method of densifying the hollow molded body, there are a method in which the hollow molded body is heated so as to melt only the surface of the inorganic fiber confounded structure and a method in which the surface of the hollow molded body is coated with a heat resistant film or the like. However, the method of densifying the hollow molded body is not limited to these exemplified methods and any method may be used insofar as an escape of the inorganic powder is prevented.

The bulk density of the hollow molded body is, though not particularly limited, at least about 0.35 g/cm³ and at most about 0.45 g/cm³. The bulk density may be found as a value obtained by dividing the weight by the apparent volume (see JIS A0202).

When the bulk density is about 0.35g/cm³or more, convection heat transfer and molecular heat transfer tends to be prevented from increasing, whereas when the bulk density is about 0.45 g/cm³or less, solid heat conduction is less likely to be increased and therefore the thermal conductivity tends to be prevented from increasing. Therefore, in any of these cases, it is likely that a sufficient heat insulation property is obtained easily.

The contents of JIS A 0202 are incorporated herein by reference in their entirety.

(Hollow Part of the Hollow Molded Body)

The hollow part of the hollow molded body is a closed space which is capable of receiving a filler and is formed inside of the hollow molded body.

The hollow part is formed as one partition (specifically, only one closed space inside of the hollow molded body) inside of the hollow molded body. However, the hollow part is not limited to one partition but may be formed as a multi-partition consisting of two or more partitions.

A heat insulating material having a multi-partition structure and/or a multilayer structure may be constituted as a whole by forming the hollow part as a multi-partition.

(Filler)

The filler to be filled in the hollow part of the hollow molded body comprises at least an inorganic powder.

As the inorganic powder, the inorganic powder described in the explanations of the hollow molded body may be preferably used. The inorganic powder may be used independently or two or more kinds thereof may be used in combination. When inorganic powders are used in combinations, the combinations of inorganic powders as described in the explanations of the hollow molded body may be used as desirable combinations. Convection heat transfer, molecular heat transfer and radiation heat transfer can be suppressed efficiently by filling the aforementioned filler made of at least the inorganic powder in the hollow part.

The filler may further contain inorganic fiber.

If the filler further contains inorganic fiber, the light having a wavelength which cannot be reflected or diffused only by the inorganic powder can be reflected and distributed, making it possible to aid the heat insulating material according to the embodiments of the present invention in improving the heat insulation property thereof.

As the inorganic fiber contained in the filler, the inorganic fiber as described in the explanations of the hollow molded body may be used. Like the inorganic powder, the inorganic fibers may be used independently or two or more kinds thereof may be used in combination.

The bulk density of the filler to be filled in the heat insulating material according to the embodiments of the present invention is at least about 0.15 g/cm³ and at most about 0.4 g/cm³.

When the bulk density of the filler is about 0.15 g/cm³ or more, an increase in void parts which occurs when the filler is refilled by external actions such as oscillation, can be prevented and thus a sufficient heat insulation property is likely to be obtained. On the other hand, when the bulk density about 0.4 g/cm³or less, the influence of solid heat conduction tends to become small, to thereby obtain a sufficient heat insulation property more easily. Also, because the heat capacity of the whole heat insulating material is likely to be prevented from increasing and the amount of heat accumulation is therefore less likely to increase, the energy required to heat the whole system tends to become small.

When the filler is a mixture of the above-mentioned materials, it is needless to say that the bulk density means the bulk density of the whole mixture.

In the case where the hollow part is formed so as to have a multi-partition structure and/or a multilayer structure, the bulk densities of the fillers in each partition and each layer may be the same or different. The filler may be filled in the hollow part in a desired bulk density as long as the bulk density is in the above-mentioned range.

Next, the method for manufacturing the heat insulating material according to the embodiments of the present invention will be explained.

(Method for Manufacturing the Heat Insulating Material)

The heat insulating material according to the embodiments of the present invention is manufactured by producing a hollow molded body by die-forming a hollow molded body made of at least the inorganic fiber and filling at least inorganic powder in the hollow part of the hollow molded body to form a filler. The hollow molded body may be manufactured by any method including a dry molding method or a wet molding method. The method for manufacturing the heat insulating material according to the embodiments of the present invention in the case of obtaining the hollow molded body by each molding method will be explained hereinafter.

(a) The case of using a hollow molded body obtained by a dry molding method.

First, in a dry molding method, the inorganic fiber and, according to the need, the inorganic powder, the inorganic binder and the organic elastic material are charged at a predetermined ratio into a mixer such as a V-type mixer. These components are mixed well and charged into a predetermined die to be pressed, thereby obtaining a hollow molded body having an opening at a part thereof. At the time of pressing, heat may be applied to the mixture according to the need.

The hollow molded body may be integrated so as to have a hollow part or may be formed by partially molding according to the need and then combining a plurality of the obtained divided molded products to manufacture a hollow molded body.

The pressure for the pressing is desirably at least about 0.98 MPa and at most about 9.8 MPa. When the pressing pressure is in the above-mentioned range, it becomes easier for the obtained hollow molded body to maintain its strength. Further, excess compression is less likely to cause deteriorated processability and also, the bulk density is prevented from becoming so high that the increase in solid heat conduction is likely to be prevented, to thereby obtain a sufficient heat insulation property more easily.

Also, the heating temperature during pressing is desirably at least about 200° C. and at most about 400° C. in the case where the organic elastic material is contained and in the range of about 400° C. to about 700° C. when the organic elastic material is not contained. When the heating temperature is in this range, it becomes easier to maintain sufficient heat insulation property while retaining a proper processability.

Then, the filler is filled in the hollow part through the opening such that a predetermined bulk density is obtained, and then, the opening is closed by the molded product produced separately in advance so as to have a shape that can just cover the opening, to obtain a heat insulating material according to the embodiments of the present invention. Examples of the method for filling the filler include methods utilizing mechanical compression, oscillation, deaeration and methods obtained by combining these methods.

The molded product may be secured by using an inorganic adhesive and the like so as to cover the opening. Also, it is possible to impregnate the obtained molded body or molded product with an inorganic binder before filling the filler in the hollow part.

(b) The case of using a hollow molded body obtained by a wet molding method.

Next, in a wet molding method, the inorganic fiber and, according to the need, the inorganic powder and the inorganic binder are mixed and stirred in water to fully disperse these components. Then, an aqueous aluminum sulfate solution and the like is added as a coagulator to the mixture, to obtain a primary coagulate made of the inorganic fiber with the inorganic powder and inorganic binder adhered along its surface. Next, according to need, an emulsion or the like of the organic elastic material is added in the water in an amount falling in a predetermined range and then, a cationic polymer coagulant is added to the mixture to obtain a slurry containing a coagulate.

Here, when the organic elastic material is further used as the structural materials of the hollow molded body, it becomes difficult to adhere the inorganic binder along the fiber and it is significantly difficult to retain strength at high temperatures if the order of the additions of the aqueous aluminum sulfate solution and organic elastic material is reversed; therefore the order of the addition must especially be paid attention to.

Next, the slurry containing a coagulate is charged into a predetermined die, which is then evacuated to obtain a wet hollow molded body having an opening at a part thereof. The obtained hollow molded body is dried to obtain a hollow molded body at a part thereof.

Here, the water content of the hollow molded body before it is dried is preferably about 200% or less. This is because the case where the hollow molded body shrinks when it is dried is less likely to occur, so that the intended dimension tends to be obtained with ease.

If it is intended to produce a solid molded body by a method using such wet molding, the inorganic powder is densely molded in the early stage and it is difficult to evacuate the slurry successively. However, in the case of producing a hollow molded body having such a wall thickness as mentioned above, the problem which arises in the production of the solid molded body does not occur and also from this point, the structure according to the embodiments of the present invention produces an advantageous effect on an improvement in moldability.

Then, in the same manner as in the dry molding method, the filler is filled in the hollow part of the hollow molded body obtained in the above-mentioned process through the opening such that a predetermined bulk density is obtained, and then, the opening is closed by the molded product produced from the mixture by a wet molding separately in advance so as to have a shape that can just cover the opening, to obtain a heat insulating material according to the embodiments of the present invention. Examples of a method of filling the filler and a method of closing the opening include those described in the explanations of the dry molding method (a).

The hollow molded body may be molded by a die (or metal mold) of a desired shape to an integrated body or separated parts. Because the hollow molded body is constituted of at least the inorganic fiber and therefore has excellent moldability and processability, it can be easily and efficiently manufactured also by the integrated molding which is conventionally applied with difficulty.

As mentioned above, the hollow molded body may be obtained by any of the dry molding method and wet molding method. It is however preferable that the molded body is one obtained by the wet molding from the viewpoint of easiness of integrated molding and mechanical strength.

In the heat insulating material according to the embodiments of the present invention which is obtained in the above-mentioned manner, the strength is reinforced by inorganic fiber and also, the strength when the heat insulating material is used at high temperatures is retained in the case of using an inorganic binder. Also, the inclusion of the inorganic fiber improves the moldability and processability, enabling integrated molding of the hollow molded body in accordance to the shape of a subject material to be insulated. This ensures that in the heat insulating material according to the embodiments of the present invention, which is different from the conventional heat insulating material prepared by assembling many heat insulating materials, no void exist among heat insulating materials and also the number of divided parts is very small and each divided parts are formed precisely even if the heat insulating material is formed by assembling separated parts, which makes it possible to outstandingly limit the generation of voids among the heat insulating materials and the heat insulating material according to the embodiments of the present invention can exhibit excellent heat insulation property.

Also, the use of the inorganic powder limits the convection of the air present in avoid inside of the heat insulating material and molecular heat transfer and further, allows radiation heat to be diffused whereby excellent insulating properties can be obtained. As mentioned above, in a heat insulating material having the structure according to the embodiments of the present invention, the compatibility between heat insulation property, moldability/processability can be attained.

It is to be noted that the hollow molded body produced by the wet molding method using the organic elastic material can be improved in flexibility in an efficient manner.

The heat insulating material according to the embodiments of the present invention may be used in various uses. It is useful, for example, as a heat insulating material for insulating a fuel cell reformer.

A fuel cell is an energy supply source using hydrogen and oxygen as fuels and attracts remarkable attention as a clean power generating system. The hydrogen as the fuel is obtained by converting city gas or alcohols into hydrogen by a catalytic reaction in the reformer. At this time, the temperature of the catalyst which is required for the catalytic reaction by combustion is at a high temperature of at least about 600° C. and at most about 900° C. and it is therefore necessary to insulate the outside of the reformer.

Here, many fuel cell reformers have a cylindrical form and therefore, in conventional cases, plural heat insulating materials are combined to assemble them and slits are formed in the heat insulating materials to make these heat insulating materials accord to the shape of the reformer. However, in this case, voids are generated among the heat insulating materials and between the reformer and the heat insulating materials and therefore only insufficient heat insulation property is obtained.

The heat insulating material according to the embodiments of the present invention enables integrated molding into a shape fitted to the shape of the reformer though the conventional heat insulating materials have not been produced by such integrated molding. Therefore, the whole subject material to be insulated can be fully covered with the integrated heat insulating material and also the generation of voids can be prevented by the adhesion between the reformer and the heat insulating material, whereby excellent insulating effects can be obtained.

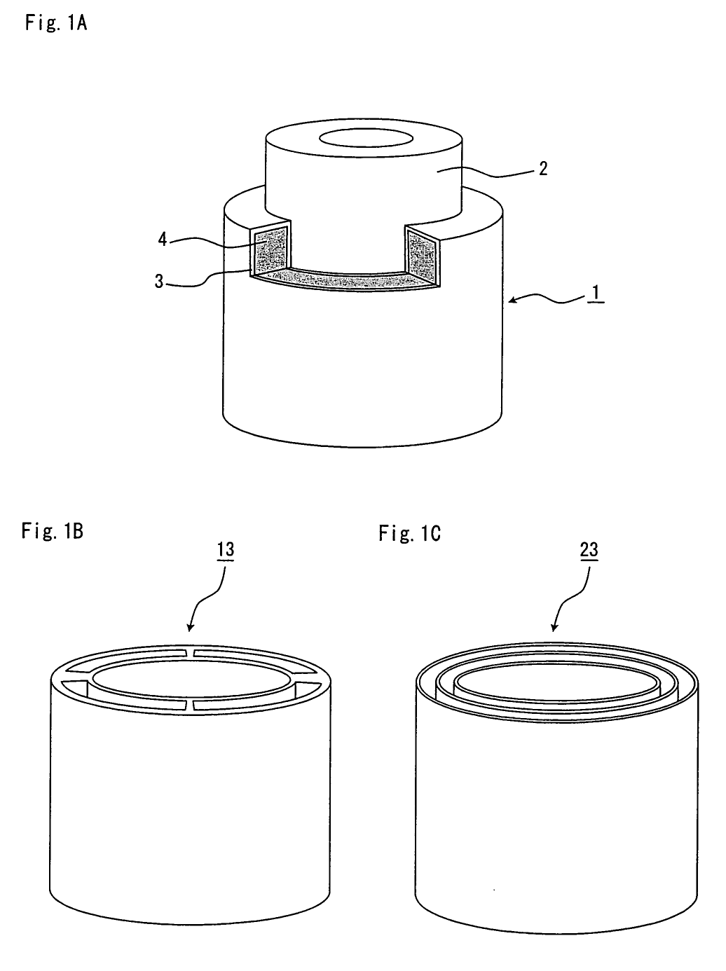

FIG. 1A is a perspective view schematically showing an example of the heat insulating material according to one embodiment of the present invention which is set to the reformer. FIG. 1B is a perspective view schematically showing one example of the hollow molded body constituting the heat insulating material according to another embodiment of the present invention. FIG. 1C is a perspective view schematically showing another example of the hollow molded body constituting the heat insulating material according to yet another embodiment of the present invention.

A double tube-shaped heat insulating material 1 is set to the outside periphery of a reformer 2 having a cylindrical form without any void. Also, the heat insulating material 1 comprises a hollow molded body 3 and a filler 4 filled in a hollow part inside of the hollow molded body 3. The length in the longitudinal direction and inside diameter of the heat insulating material 1 may be adjusted corresponding to the size of the reformer to be used.

Also, in FIG. 1A, the hollow part filled with the filler 4 is formed as one partition and therefore, the hollow molded body constituting the heat insulating material 1 is provided with a hollow part having monolayer structure. However, the form of the hollow molded body constituting the heat insulating material according to the embodiments of the present invention is not limited to that of the hollow molded body. The hollow molded body may have a structure in which the circumference of a double-tube shape is divided into four partitions as the hollow part like the hollow molded body 13 shown in Fig. 1B or a structure in which a hollow part having a double-layer structure spread in the direction of the diameter concentrically from the center of the tube like the hollow molded body 23 as shown in FIG. 1C. Figs. 1B and 1C show only the hollow molded body. No particular limitation is imposed on the number of partitions and the number of layers and the hollow molded part may be formed irrespective of the number of partitions or layers. Also, the hollow part may be formed such that it has a multi-partition and multilayer structure obtained by combining the structures shown in FIG. 1B and 1C with each other.

The heat insulating material according to the embodiments of the present invention ensures that it can be miniaturized and has complicated shapes by integrated molding.

Therefore, the heat insulating material according to the embodiments of the present invention may be effectively applied not only to a fuel cell reformer used in a stationary power generating system but also to a fuel cell reformer used in a power generating system of limited space, such as fuel cell cars.

As described so far, the heat insulating material according to the embodiments of the present invention comprises a hollow molded body made of at least an inorganic fiber and a filler which is filled in the hollow part of the hollow molded body and is made of at least an inorganic powder. Therefore, the heat insulating material according to the embodiments of the present invention can exhibit complex characteristics including the mechanical strength and processability/moldability of the hollow molded body and the heat insulation property of the filler and can therefore attain the compatibility between heat insulation property and processability/moldability which could not be attained by the conventional heat insulating materials.

Particularly, because the heat insulating material according to the embodiments of the present invention has the above-mentioned configuration, it can be molded into a shape consistent with a subject body to be insulated even if it is any of an integrated molded body and a divided molded body and can be simply assembled with the subject body to be insulated.

Specifically, when the heat insulating material according to the embodiments of the present invention is constituted of an integrated molded body, the gaps existing in general when plural heat insulating materials are combined with one another are not present among the heat insulating materials. Also, even in the case where the heat insulating material according to the embodiments of the present invention is constituted of divided molded bodies, the number of molded bodies which are divided is extremely small and therefore, the generation of voids among the heat insulating materials can be likewise suppressed to the utmost. Also, since the generation of voids between the heat insulating material and the subject material to be insulated can be prevented, the heat insulating material according to the embodiments of the present invention is free from the leakage of heat out of the heat insulating material, making it possible to exhibit excellent insulating ability.

Also, as mentioned above, the heat insulating material according to the embodiments of the present invention can be easily processed and molded into a shape corresponding to its use while retaining heat insulation property, so that the range of its applications can be expanded.

Particularly, the heat insulating material according to the embodiments of the present invention may be effectively applied to a fuel cell reformer having an outer form of a cylinder, whereby safety in use and cost performance can be improved.

### EXAMPLES

The embodiments of the present invention will be explained in more detail by way of examples, which are not intended to be limiting of the embodiments of the present invention.

### Examples 1 to 12

A so-called shot-reduced bulk material (trade name: IBI-Wool, manufactured by Ibiden Co., Ltd.) prepared by removing coarse particles from silica-alumina based ceramic fiber as inorganic fiber constituting a hollow molded body was added in a necessary amount of water to loosen the fibers.

Then, 24% by weight of a TiO₂ powder (trade name: Rutile Flower, manufactured by Kinsei Matec Co., Ltd.) and 49%by weight of a SiO₂ powder (trade name: CARPREX, manufactured by Shionogi & Co., Ltd.) were added as an inorganic powder of the hollow molded body to the mixture, which was then sufficiently mixed. Then, 3% by weight of colloidal silica (trade name: SNOWTEX, manufactured by Nissan Chemical Industries Ltd.) was further added as an inorganic binder to the mixture, which was then thoroughly stirred and mixed. The compounding amount of the shot-reduced bulk material was 24% by weight. An aqueous aluminum sulfate was further added as a coagulant to the mixture to obtain a primary coagulant. Then, a cationic polymer coagulant was added to the primary coagulant to once again coagulate the primary coagulant so that a slurry was prepared.

The slurry was molded in a metal mold to obtain a double-tube shaped hollow molded body with an open end at the upper surface, and having an inside diameter of 90 mm, an outside diameter of 200 mm, a thickness of 5 mm and a height of 300 mm. This hollow molded body was dried under the condition of 110° C. for 8 hours.

Next, 34% by weight of the TiO₂ powder and 66% by weight of the SiO₂ powder were thoroughly stirred and mixed by a mixer to obtain a powder mixture as a filler. The obtained powder mixture was filled in the hollow part of the double-tube shaped hollow molded body in the bulk densities shown in Table 1 by oscillation and compression. Then, the opened upper surface of the hollow molded body was closed with a disk-shaped molded product made in advance into the same form as the opening by using the same materials that were used for the hollow molded body, to obtain an integrated heat insulating material as shown in FIG. 1A. The disk-shaped molded product was secured by applying and curing an inorganic adhesive.

A heater was disposed inside of the heat insulating material obtained in the Examples and heated to 600° C. to measure a thermal conductivity (W/mK) of the heat insulating material. The results of the measurement are shown in Table 1.

TABLE 1

| | Bulk density | Thermal conductivity |
|---|---|---|
| | (g/cm³) | (W/mK) |
| Example 1 | 0.10 | 0.1672 |
| Example 2 | 0.14 | 0.0731 |
| Example 3 | 0.15 | 0.0522 |
| Example 4 | 0.18 | 0.0418 |
| Example 5 | 0.22 | 0.0366 |
| Example 6 | 0.26 | 0.0350 |
| Example 7 | 0.30 | 0.0392 |
| Example 8 | 0.34 | 0.0460 |
| Example 9 | 0.38 | 0.0543 |
| Example 10 | 0.40 | 0.0596 |
| Example 11 | 0.42 | 0.0836 |
| Example 12 | 0.46 | 0.1358 |

(Note)
Each value of the thermal conductivity is a value measured at 600° C.

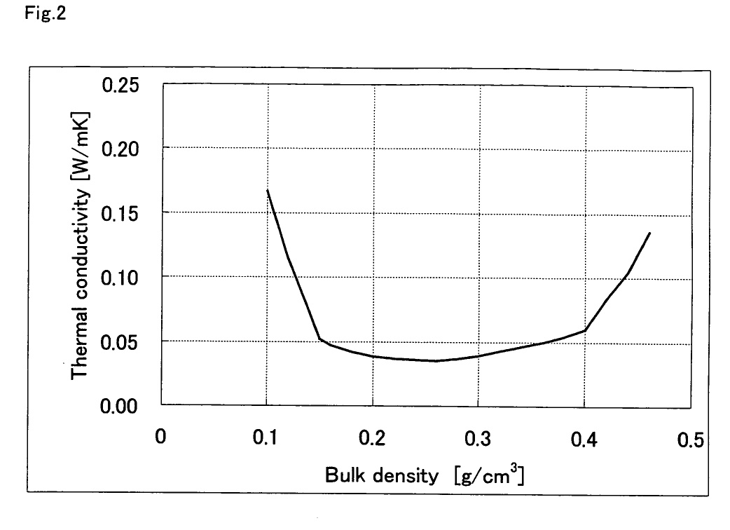

As shown in Table 1, each of the heat insulating materials obtained in Examples showed excellent heat insulation property in general though it is an integrated molded type heat insulating material, and accomplishes the compatibility between heat insulation property and moldability/processability, though such compatibility has not been attained by the conventional product. Moreover, Examples 3 to 10, as is clear from FIG. 2, each had a thermal conductivity of 0.06 W/mK or less and it is therefore found that particularly excellent heat insulation property was exhibited when the bulk density of the filler was in the range of 0.15 to 0.4 g/cm³.

FIG. 2 is a graph obtained by plotting a relationship between a change in the bulk density (g/cm³) of the filler and a change in the thermal conductivity (W/mK) of the integrated molded type heat insulating material according to the embodiments of the present invention when the heat insulating material was heated to 600° C., shown in Table 1.

Also, when the heater was disposed inside of the integrated molded type heat insulating material obtained in Example 6 and heated to 800° C., the temperature of the outside peripheral wall of the heat insulating material was about 50° C., and therefore, the heat insulating material exhibited excellent heat insulation property.

### Comparative Example 1

A commercially available plate-shaped microporous type heat insulating material (trade name: MICROTHERM, manufactured by Nippon Microtherm Co.Ltd.) (50 mm in thickness) was processed into a disk-shaped material having an inside diameter of 90 mm and an outside diameter of 200 mm by mechanic processing. Six of these heat insulating materials were piled up one after another so as to have a height of 300 mm to make a multi-divided type heat insulating material having the same shape as the Examples.

When a heater was disposed in the inside of the heat insulating material obtained in Comparative Example 1 and heated to a temperature of 800° C., the temperature in the vicinity of the contact part between the heat insulating materials was about 80° C. and sufficient heat insulation property could not be obtained.

### Comparative Example 2

In the same manner as in the Examples, 83% by weight of ceramic fiber, 14% by weight of a TiO₂ powder and 3% by weight of colloidal silica were mixed and stirred in water and an aqueous aluminum sulfate solution was added as a coagulant to the mixture to obtain a primary coagulate and then a cationic polymer coagulant was added to the mixture to once again coagulate the primary coagulate so that a slurry was prepared. The slurry was molded using a metal mold, to obtain a solid molded body having the same outer shape (inside diameter: 90 mm, outside diameter: 200 mm and height: 300 mm) as those produced in the Examples. Therefore, the molded body of Comparative Example 2 has no hollow part to be filled with the filler 4 as in FIG. 1A.

When a heater was disposed in the inside of the solid molded body and heated to a temperature of 800° C., the temperature of the outside wall was about 90° C. though the solid molded body had an integrated molded body type shape and therefore, sufficient heat insulation property could not be obtained.

What is claimed as new and desired to be secured by Letters Patent of the United States is:

1. A heat insulating material comprising:
a hollow molded body made of at least an inorganic fiber; and
a filler which is filled in a hollow part of said hollow molded body and made of at least an inorganic powder.

2. The heat insulating material according to claim 1,
wherein
said inorganic fiber contained in said hollow molded body has an average fiber length of at least about 0.1 mm and at most about 50 mm.

3. The heat insulating material according to claim 2,
wherein
said inorganic fiber contained in said hollow molded body has an average fiber length in the range of about 0.5 mm to about 10 mm.

4. The heat insulating material according to claim 1,
wherein
said inorganic fiber contained in said hollow molded body has an average fiber diameter of at least about 1 μm and at most about 10 μm.

5. The heat insulating material according to claim 4,
wherein
said inorganic fiber contained in said hollow molded body has an average fiber diameter in the range of about 2 μm to about 5 μm.

6. The heat insulating material according to claim 1,
wherein
the compounding amount of said inorganic fiber in said hollow molded body is at least about 5% by weight and at most about 50% by weight.

7. The heat insulating material according to claim 6,
wherein
the compounding amount of said inorganic fiber in said hollow molded body is in the range of about 10% by weight to about 40% by weight.

8. The heat insulating material according to claim 1,
wherein
said hollow molded body further contains an inorganic powder.

9. The heat insulating material according to claim 8,
wherein
the compounding amount of said inorganic powder in said hollow molded body is at least about 50% by weight and at most about 95% by weight.

10. The heat insulating material according to claim 9,
wherein
the compounding amount of said inorganic powder in said hollow molded body is in the range of about 60% by weight to about 90% by weight.

11. The heat insulating material according to claim 8,
wherein
the average particle diameter of said inorganic powder contained in said hollow molded body is at least about 0.5 μm and at most about 20 μm.

12. The heat insulating material according to claim 11,
wherein
the average particle diameter of said inorganic powder contained in said hollow molded body is in the range of about 1 μm to about 10 μm.

13. The heat insulating material according to claim 8,
wherein
said inorganic powder contained in said hollow molded body has a ratio of refractive index of about 1.25 or more for light having a wavelength of 1 μm or more.

14. The heat insulating material according to claim 8,
wherein
said inorganic powder contained in said hollow molded body has a reflectance of about 70% or more for light having a wavelength of 10 μm or more.

15. The heat insulating material according to claim 8,
wherein
the solid heat conductivity of said inorganic powder contained in said hollow molded body is about 20.9 W/mK or less at room temperature.

16. The heat insulating material according to claim 1,
wherein
said hollow molded body further contains an inorganic binder.

17. The heat insulating material according to claim 1,
wherein
said hollow molded body further contains an organic elastic material.

18. The heat insulating material according to claim 1,
wherein
the wall thickness of said hollow molded body is at least about 3 mm and at most about 20 mm.

19. The heat insulating material according to claim 1,
wherein
a part or all of said hollow molded body is made to have a densified structure.

20. The heat insulating material according to claim 1,
wherein
the bulk density of said hollow molded body is at least about 0.35 g/cm³ and at most about 0.45 g/cm³.

21. The heat insulating material according to claim 1,
wherein
said inorganic powder contained in said filler has an average particle diameter of at least about 0.5 μm and at most about 20 μm.

22. The heat insulating material according to claim 21,
wherein
said inorganic powder contained in said filler has an average particle diameter in the range of about 1 μm to about 10 μm.

23. The heat insulating material according to claim 1,
wherein
said inorganic powder contained in said filler has a ratio of refractive index of about 1.25 or more for light having a wavelength of 1 μm or more.

24. The heat insulating material according to claim 1,
wherein
said inorganic powder contained in said filler has a reflectance of about 70% or more for light having a wavelength of 10 μm or more.

25. The heat insulating material according to claim 1,
wherein
the solid heat conductivity of said inorganic powder contained in said filler is about 20.9 W/mK or less at room temperature.

26. The heat insulating material according to claim 1,
wherein
said filler further contains an inorganic fiber.

27. The heat insulating material according to claim 26,
wherein
the average fiber length of said inorganic fiber contained in said filler is at least about 0.1 mm and at most about 50 mm.

28. The heat insulating material according to claim 27,
wherein
the average fiber length of said inorganic fiber contained in said filler is in the range of about 0.5 mm to about 10 mm.

29. The heat insulating material according to claim 26,
wherein
the average fiber diameter of said inorganic fiber contained in said filler is at least about 1 μm and at most about 10 μm.

30. The heat insulating material according to claim 29,
wherein
the average fiber diameter of said inorganic fiber contained in said filler is in the range of about 2 μm to about 5 μm.

31. The heat insulating material according to claim 1,
wherein
said filler has a bulk density of at least about 0.15 g/cm³ and at most about 0.4 g/cm³.

32. The heat insulating material according to claim 1,
wherein
said hollow molded body is a molded body obtained by wet molding.
